(19) United States
(12) Patent Application Publication
(10) Pub. No.: US 2016/0257022 A1
(43) Pub. Date: Sep. 8, 2016

(54) BAMBOO SHOOT SQUEEZING APPARATUS

(71) Applicant: ZEBANG OPERATION LIMITED, HONG KONG (HK)

(72) Inventor: Zihu Chen, Shenzhen (CN)

(21) Appl. No.: 15/157,349

(22) Filed: May 17, 2016

Related U.S. Application Data
(63) Continuation of application No. PCT/CN2013/085850, filed on Oct. 24, 2013.

(51) Int. Cl. B27K 9/00; A23B 7/00

(52) U.S. Cl. CPC B27K 9/002; A23B 7/00; B27K 2240/10

(57) ABSTRACT

A bamboo shoot squeezing apparatus is provided underground and includes a case, a pressure generation element, and a fixing beam. The case includes a bottom wall, a sidewall, a support piece, and a pressing board. The sidewall and the bottom wall are connected to form a column-shaped cavity, the support piece is fixed on the sidewall and is located above the bottom wall, the pressing board is inside the column-shaped cavity and is located above the support piece, the pressing board, the support piece, and the sidewall together form a squeezing cavity, the fixing beam is located above the pressing board and is fixed on the ground, and the pressure generation element is clamped between the pressing board and the fixing beam. The bamboo shoot squeezing apparatus has an advantage of extending a storage period of bamboo shoots and an advantage of a long service life.

### FIELD OF THE DISCLOSURE

The disclosure relates to a squeezing apparatus, and more particularly to a bamboo shoot squeezing apparatus.

### BACKGROUND OF THE DISCLOSURE

A bamboo shoot is an excellent vegetable rich in protein, amino acids, fats, sugar, calcium, phosphorus, iron, carotene and multivitamins.

China offers a wide variety of bamboos, most bud of which can be edible as bamboo shoots. Phyllostachys edulis, for example, is a common species of bamboo, its bud is fresh, but hard to be stored and transported over long distance.

A conventional method before storage and transportation of a bamboo shoot is peeling, steaming or boiling, squeezing and sun drying after digging it out.

In a conventional squeezing process of a bamboo shoot, a squeezing case can be made of woods, in which a beam is applied as a lever structure to squeeze bamboo shoots in the squeezing case. However, with such a conventional squeezing device, bamboo shoots in the squeezing case are perishable during a process of squeezing bamboo shoots, which are difficult to be preserved for a long period. Moreover, materials of a squeezing device are woods, limited in service life, multiple accessories need to be renewed every two or three years, which is troublesome.

### SUMMARY OF THE DISCLOSURE

The disclosure provides a bamboo shoot squeezing apparatus that can extend a storage period of bamboo shoots with a long service life.

A bamboo shoot squeezing apparatus is disposed underground, the bamboo shoot squeezing apparatus includes a case, a pressure generation element and a fixing beam, the case includes a bottom wall, a sidewall, a support piece and a pressing board, the sidewall and the bottom wall are connected to form a column-shaped cavity, the support piece is fixed on the sidewall and is located above the bottom wall, the pressing board is inside the column-shaped cavity and is located above the support piece, the pressing board, the support piece and the sidewall together form a squeezing cavity, the fixing beam is located above the pressing board and is fixed on the ground, the pressure generation element is clamped between the pressing board and the fixing beam.

The sidewall is formed by concrete, a thickness of the sidewall is 1-80 centimeters.

The pressure generation element is a jack.

The fixing beam is fixed on the ground by concrete pouring.

A horizontal cross section of the squeezing cavity is rectangular or round.

The bamboo shoot squeezing apparatus further includes a packaging material, the packaging material is disposed on an inner wall of the squeezing cavity.

The packaging material is a plastic film.

The bamboo shoot squeezing apparatus further includes a liquid discharge passage, the liquid discharge passage is adjacent to the bottom wall.

A pump is disposed on the liquid discharge passage.

The amount of the cases and that of the pressure generation elements are respectively more than or equal to two.

As the bamboo shoot squeezing apparatus above is disposed underground, which can prevent the entire apparatus from being radiated by direct sunshine, hence temperature inside the bamboo shoot squeezing apparatus is decreased, making bamboo shoots to be stored with relatively lower ambient temperature, in favor of preventing a bamboo shoot from decaying during a squeezing process and extending squeezing or a storage period of a bamboo shoot, as well as increasing service life of the bamboo shoot squeezing apparatus; moreover, the pressure generation element clamped between the pressing board and the fixing beam tends to load high pressure on the pressing board of the bamboo shoot squeezing apparatus evenly, which can guarantee a successful squeezing process.

### BRIEF DESCRIPTION OF THE DRAWINGS

FIG. 1 is a top schematic view of a bamboo shoot squeezing apparatus according to a first embodiment the disclosure.

FIG. 2 is across-sectional view of the bamboo shoot squeezing apparatus shown in FIG. 1 taken along II-II′.

FIG. 3 is a cross-sectional view of the bamboo shoot squeezing apparatus shown in FIG. 1 taken along III-III′.

FIG. 4 is a cross-sectional view of a bamboo shoot squeezing apparatus according to a second embodiment the disclosure.

FIG. 5 is a cross-sectional view of a bamboo shoot squeezing apparatus according to a third embodiment the disclosure.

### DETAILED DESCRIPTION OF PREFERRED EMBODIMENTS

Embodiments of the disclosure are described in detail with reference to the accompanying drawings as follows.

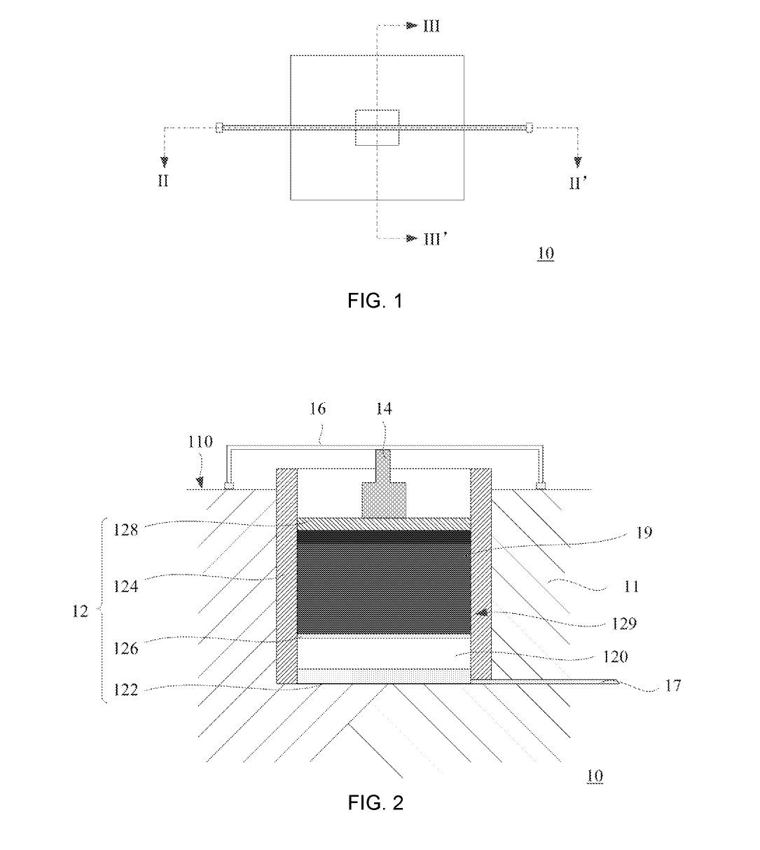

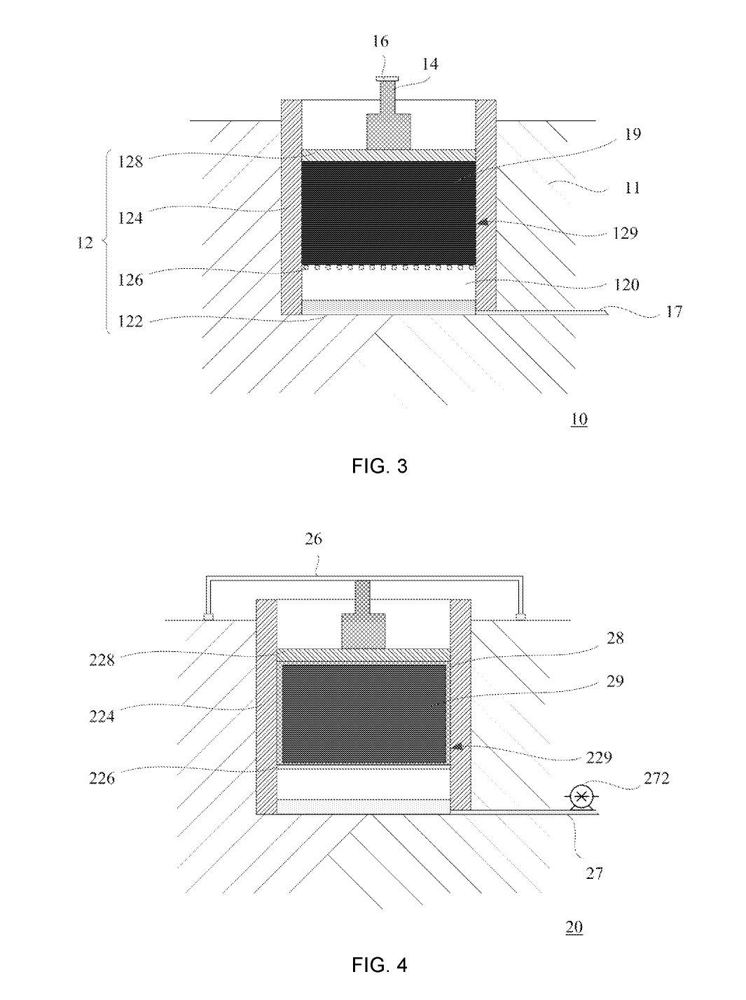

Referring to FIG. 1 through FIG. 3, a bamboo shoot squeezing apparatus 10 is disposed underground 11, the bamboo shoot squeezing apparatus 10 includes a case 12, a pressure generation element 14 and a fixing beam 16. The case 12 includes a bottom wall 122, a sidewall 124, a support piece 126 and a pressing board 128. The sidewall 124 and the bottom wall 122 are connected to form a column-shaped cavity 120. The support piece 126 is fixed on the sidewall 124 and is located above the bottom wall 122. The pressing board 128 is inside the column-shaped cavity 120 and is located above the support piece 126. The pressing board 128, the support piece 126 and the sidewall 124 together form a squeezing cavity 129. The fixing beam 16 is located above the pressing board 128 and is fixed on a ground 110. The pressure generation element 14 is clamped between the pressing board 128 and the fixing beam 16.

Specifically in the embodiment, the bottom wall 122 can be formed by the ground, or other materials, such as formed by pouring concrete. The sidewall 124 of the case 12 can be formed by concrete pouring, concrete for example is ordinary concrete or reinforced concrete; it is comprehensible that the disclosure is not limited to this, other thermally conductive materials with high strength can be utilized, such as a steel plate or an iron plate. A thickness of the sidewall 124 formed by concrete pouring can be 1-80 centimeters, depending on a material opted for concrete and strength of the sidewall 124 in practice.

The support piece 126 of the case 12 is fixed on the sidewall 124, the support piece 126 can be formed by rebar or a steel pipe, and when the sidewall 124 is formed by concrete, the support piece 126 can be positioned when the sidewall 124 is being poured, so that after concrete forming the sidewall 124 is solidification, the support piece 126 can be fixed on the sidewall 124 readily. The pressing board 128 of the case 12 can be formed by a wood board or a metal board, to press the pressing board 128 evenly, on which other pads or supporters can be disposed. A shape of the squeezing cavity 129 formed by the pressing board 128, the support piece 126 and the sidewall 124 is column, a horizontal cross section of which is preferably rectangular or round. The squeezing cavity 129 needs to be sealed to some extent, such as preventing air from circulating freely, but liquid with high pressure can be exported through the squeezing cavity 129. Furthermore, the bamboo shoot squeezing apparatus 10 can further include a liquid discharge passage 17 disposed adjacent to the bottom wall 122.

The pressure generation element 14 is applied to generate downward pressure on the pressing board 128, a jack is preferable due to its low cost.

The fixing beam 16 is applied to support the pressure generation element 14, providing sufficient support for an end of the pressure generation element 14 adjacent to the fixing beam 16. The fixing beam 16 can be a beam fixed on the ground by a fixing method for example like concrete pouring. For higher strength of the fixing beam 16, a material can be steel or iron, steel rails as an example.

During preparation, first a layer of sealing material can cover the support piece 126, such as reed; second cooked bamboo shoots 19 are arranged in the squeezing cavity 129 orderly; third the pressing board 128 is pressed on the bamboo shoots 19; fourth the pressure generation element 14 is mounted between the pressing board 128 and the fixing beam 16. When the pressure generation element 14 works, the bamboo shoots 19 in the squeezing cavity 129 can be squeezed. Liquid from the bamboo shoots 19 during a squeezing process can flow to the bottom wall 122 and be exported through the liquid discharge passage 17. It is comprehensible that when the amount of the bamboo shoots 19 squeezed by the bamboo shoot squeezing apparatus 10 is small, the bottom wall can be formed by soil or other sands, and the liquid discharge passage 17 can be omitted, liquid can flow out through soil or sands.

As the bamboo shoot squeezing apparatus 10 above is disposed underground 11, which can prevent the entire apparatus from being radiated by direct sunshine, hence temperature inside the bamboo shoot squeezing apparatus 10 is decreased, making the bamboo shoots 19 to be stored with relatively lower ambient temperature, in favor of preventing the bamboo shoots 19 from decaying during a squeezing process and extending squeezing or storage period of the bamboo shoots 19, as well as increasing service life of the bamboo shoot squeezing apparatus 10; and the bamboo shoot squeezing apparatus 10 disposed underground 11 can reduce possibility of air entering the bamboo shoot squeezing apparatus 10, further preventing the bamboo shoots 19 from decaying during the squeezing process, extending squeezing or storage period of the bamboo shoots 19; moreover, the pressure generation element 14 is clamped between the pressing board 128 and the fixing beam 16, which tends to load high pressure on the pressing board of the bamboo shoot squeezing apparatus 10 evenly, in order to guarantee a successful squeezing process of the bamboo shoots 19.

Referring to FIG. 4, it is a bamboo shoot squeezing apparatus 20 according to a second embodiment the disclosure, the bamboo shoot squeezing apparatus 20 and the bamboo shoot squeezing apparatus 10 are similar, differences are the bamboo shoot squeezing apparatus 20 further including a package material 28, and a pump 272 is disposed on a liquid discharge passage 27. The packaging material 28 can be a plastic film, which is disposed on an inner wall of a squeezing cavity 229 formed by enclosing a pressing board 228, a support piece 226 and a sidewall 224 during utilization. The package material 28 is disposed to further prevent air from entering the bamboo shoot squeezing apparatus 20, which can prevent bamboo shoots 29 from decaying during a squeezing process. The pump 272 disposed on the liquid discharge passage 27 can assist to export liquid squeezing from the bamboo shoots 29, which can cause rancidity.

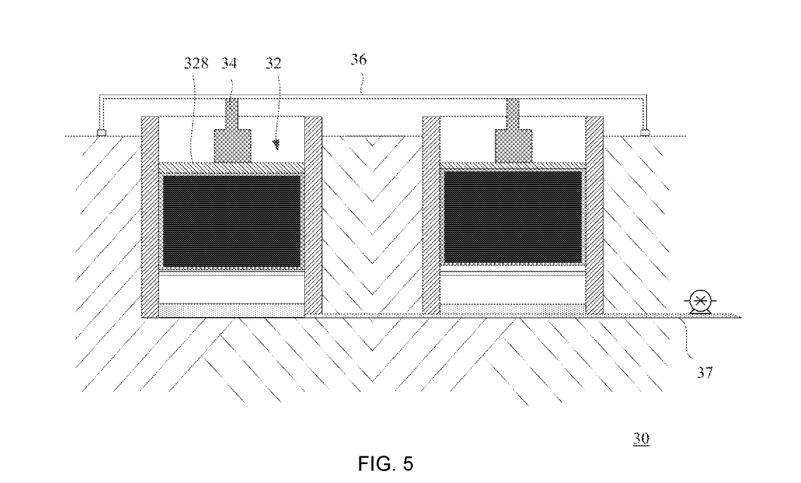

Referring to FIG. 5, it is a bamboo shoot squeezing apparatus 30 according to a third embodiment the disclosure, the bamboo shoot squeezing apparatus 30 and the bamboo shoot squeezing apparatus 20 are similar, differences are the bamboo shoot squeezing apparatus 30 including two cases 32 and two pressure generation elements 34; the two pressure generation elements 34 are corresponding to the two cases 32 respectively, supporting between pressing boards 328 of the cases 32 and a fixing beam 36; moreover, a liquid discharge passage 37 penetrates the two cases 32. Multiple cases 32 applied together tend to realize scale production of squeezing bamboo shoots, and decrease costs in a process of squeezing bamboo shoots.

Above are merely preferred embodiments of the disclosure, which does not limit the scope of the disclosure, any modifications, equivalent replacements or improvements within the spirit and principles of the disclosure should be covered by the protected scope of the disclosure.

What is claimed is:

1. A bamboo shoot squeezing apparatus, wherein the bamboo shoot squeezing apparatus is disposed underground, the bamboo shoot squeezing apparatus comprises a case, a pressure generation element and a fixing beam, the case comprises a bottom wall, a sidewall, a support piece and a pressing board, the sidewall and the bottom wall are connected to form a column-shaped cavity, the support piece is fixed on the sidewall and is located above the bottom wall, the pressing board is inside the column-shaped cavity and is located above the support piece, the pressing board, the support piece and the sidewall together form a squeezing cavity, the fixing beam is located above the pressing board and is fixed on the ground, the pressure generation element is clamped between the pressing board and the fixing beam.

2. The bamboo shoot squeezing apparatus according to claim 1, wherein the sidewall is formed by concrete, a thickness of the sidewall is 1-80 centimeters.

3. The bamboo shoot squeezing apparatus according to claim 1, wherein the pressure generation element is a jack.

4. The bamboo shoot squeezing apparatus according to claim 1, wherein the fixing beam is fixed on the ground by concrete pouring.

5. The bamboo shoot squeezing apparatus according to claim 1, wherein a horizontal cross section of the squeezing cavity is rectangular or round.

6. The bamboo shoot squeezing apparatus according to claim 1, wherein the bamboo shoot squeezing apparatus further comprises a packaging material, the packaging material is disposed on an inner wall of the squeezing cavity.

7. The bamboo shoot squeezing apparatus according to claim 1, wherein the packaging material is a plastic film.

8. The bamboo shoot squeezing apparatus according to claim 1, wherein the bamboo shoot squeezing apparatus further comprises a liquid discharge passage, the liquid discharge passage is adjacent to the bottom wall.

9. The bamboo shoot squeezing apparatus according to claim 1, wherein a pump is disposed on the liquid discharge passage.

10. The bamboo shoot squeezing apparatus according to claim 1, wherein the amount of the cases and that of the pressure generation elements are respectively more than or equal to two.
